(19) United States
(12) Patent Application Publication
(10) Pub. No.: US 2004/0240320 A1
(43) Pub. Date: Dec. 2, 2004

(54) Seismic energy source for use during wellbore drilling

(75) Inventors: William J. McDonald, Houston, TX (US); Gerard T. Pittard, Houston, TX (US); Fritz W. Reuter, Houston, TX (US)

Correspondence Address: BAKER BOTTS L.L.P., 2001 ROSS AVENUE, SUITE 600, DALLAS, TX, 75201-2980, US

(73) Assignee: NOBLE DRILLING SERVICES, INC.

(21) Appl. No.: 10/775,455

(22) Filed: Feb. 10, 2004

Related U.S. Application Data
(60) Provisional application No. 60/446,446, filed on Feb. 11, 2003.

(51) Int. Cl. G01V 1/44

(52) U.S. Cl. 367/25; 181/104

(57) ABSTRACT

A seismic energy source for use while drilling a wellbore is disclosed. The source includes a drive shaft adapted to be coupled in a drill string, and a housing rotatably supported outside the drive shaft. At least one contact member is disposed on an exterior of the housing and is selectively urged into contact with a wall of a wellbore surrounding the housing. The source includes means for selectively controlling a force applied to the at least one contact member.

### RELATED APPLICATION

This application claims the priority under 35 U.S.C. § 119 of U.S. Provisional Application Ser. No. 60/446,446 filed Feb. 11, 2003.

### TECHNICAL FIELD OF THE INVENTION

The invention relates generally to the field of seismic methods of subsurface geological mapping and correlation. More specifically, the invention relates to seismic energy sources that are used in wellbores drilled through the earth.

### BACKGROUND OF THE INVENTION

Seismic geological mapping techniques known in the art include seismic surveys made from within wellbores drilled through the earth. Such surveys are known in the art as “vertical seismic profile” surveys (“VSPs”). One objective of obtaining a VSP in a wellbore is to be able to determine the velocity of seismic energy through the various layers of the earth by directly measuring seismic travel time from the earth's surface to a known depth within the wellbore in the earth. Velocity information is important in order to infer depths of subsurface structures mapped from surface-acquired seismic surveys.

One type of VSP technique includes actuating a seismic energy source at the earth's surface and measuring seismic travel time to a seismic receiver disposed in the wellbore at known depths. Typically such receivers are lowered to selected depths in the wellbore at one end of an armored electrical cable (“wireline”). Another VSP method, called “inverse VSP”, includes positioning a seismic energy source in a wellbore at selected depths, actuating the source and detecting seismic energy using receivers disposed at the earth's surface. Various types of seismic sources and seismic receivers are known in the art for use in a wellbore.

Although the foregoing VSP techniques are referred to for convenience as “wireline” techniques, the discussion below with respect to the limitations of such techniques is equally applicable to VSP techniques where the source or receiver is conveyed into the wellbore by means of drill pipe, coiled tubing, or the like. Irrespective of the actual conveyance mechanism used, wireline VSP techniques known in the art typically require that the wellbore already be drilled in order to position the source or receiver at any selected depth in the wellbore. In many instances, it is desirable to have an estimate of seismic velocity prior to actually drilling through particular formations, not the least important reason for which is because some formations have fluid pressure in pore spaces therein which exceeds pressures normally encountered at identical depth levels. As is well known in the art, estimates of seismic velocity may be used to make estimates of fluid pore pressure prior to drilling through these formations. Estimates of such pressures may be made, for example, using VSP techniques known in the art by temporarily stopping drilling, and inserting a receiver or source into the wellbore at or near the bottom of the wellbore and taking a so-called “checkshot” survey. In a checkshot survey, a seismic travel time from the known depth in the wellbore to the earth's surface is used to “calibrate” seismic surveys made entirely at the earth's surface in order to better estimate formation fluid pressure in as-yet-undrilled formations. However, stopping drilling to make checkshot surveys using techniques known in the art is time consuming, and thus expensive.

It is known in the art to include a seismic receiver in the drill string (drilling tool assembly) during drilling operations in order to reduce the time used to obtain VSP data while a wellbore is being drilled. In this technique, a seismic source is actuated at the earth's surface, as in other types of VSP surveys, and signals are recorded in appropriate circuits coupled to the receiver in the wellbore. Several types of wellbore seismic receivers for use during drilling are known in the art. See for example, U.S. Pat. No. 5,555,220 issued to Minto. A limitation to the technique of obtaining a VSP survey while drilling using a receiver in the drill string is that the broad range of signals detected by the receiver typically cannot be completely interpreted with available downhole processing means until the drill string (having the receiver therein) is removed form the wellbore. It is necessary to remove the receiver from the wellbore and interrogate the contents of the recording device because while-drilling measurement systems known in the art are typically limited to relatively slow forms of signal telemetry, such as mud pressure modulation or low-frequency electromagnetic telemetry. While-drilling telemetry systems known in the art are generally limited to a data rate of about 5 to 10 bits per second. As a result, even with data compression techniques known in the art, interrogating a wellbore seismic receiver substantially in real time is impracticable. Another operating consideration when using drill string mounted seismic receivers is the need to substantially stop drilling operations during the times at which seismic signals are to be detected. In many cases, the amount of acoustic noise caused by movement of the drill string within the wellbore is such that detecting seismic signals is difficult while drilling operations are in progress.

Another while-drilling VSP survey technique known in the art uses the drill bit as a seismic energy source. In this technique, a pilot sensor is mounted at the top of the drill string, and seismic sensors are deployed at the earth's surface. Signals detected by the seismic sensors are cross-correlated to the signals detected by the pilot sensor to determine the impulse response of the earth. Drill bit VSP techniques known in the art include methods for determining a closer representation of the drill bit seismic signature, and time correcting the pilot signal for seismic travel time through the drill string. Limitations of drill bit-source VSP techniques known in the art include, foremost, that roller cone drill bits must be used. In many drilling situations, it is preferable to use fixed cutter bits, such as polycrystalline diamond compact (“PDC”) bits. In such cases, it has proven substantially impossible to obtain a usable seismic signal from the bit. It is also known in the art that the seismic energy radiation pattern of roller cone bits is such that when the wellbore inclination from vertical exceeds about 30 to 40 degrees, the amount of seismic energy reaching the earth's surface proximate the equivalent surface location of the wellbore is very small. As a result of the limitations of bit-source VSP methods known in the art, the practical applications of bit-source VSPs have been limited.

Alternatively, a seismic energy source can be positioned in the wellbore and actuated at selected times during drilling. Seismic sources known in the art for use while drilling have generally not performed sufficiently well to be commercially useful. As a result, there is a need for an improved seismic energy source for use while drilling operations are in progress.

### SUMMARY OF THE INVENTION

One aspect of the invention is a seismic energy source for use while drilling a wellbore. The source according to this aspect of the invention includes a drive shaft adapted to be coupled in a drill string, and a housing rotatably supported outside the drive shaft. At least one contact member is disposed on an exterior of the housing and is selectively urged into contact with a wall of a wellbore surrounding the housing. The source includes means for selectively controlling a force applied to the at least one contact member.

Other aspects and advantages of the invention will be apparent from the following description and the appended claims.

### BRIEF DESCRIPTION OF THE DRAWINGS

FIG. 1 shows a seismic energy source for use while drilling as it is typically to be used during drilling operations.

FIG. 2 shows the seismic source of FIG. 1 in more detail.

FIG. 3 shows an alternative embodiment of an electric generator and hydraulic oil pump.

### DETAILED DESCRIPTION OF THE INVENTION

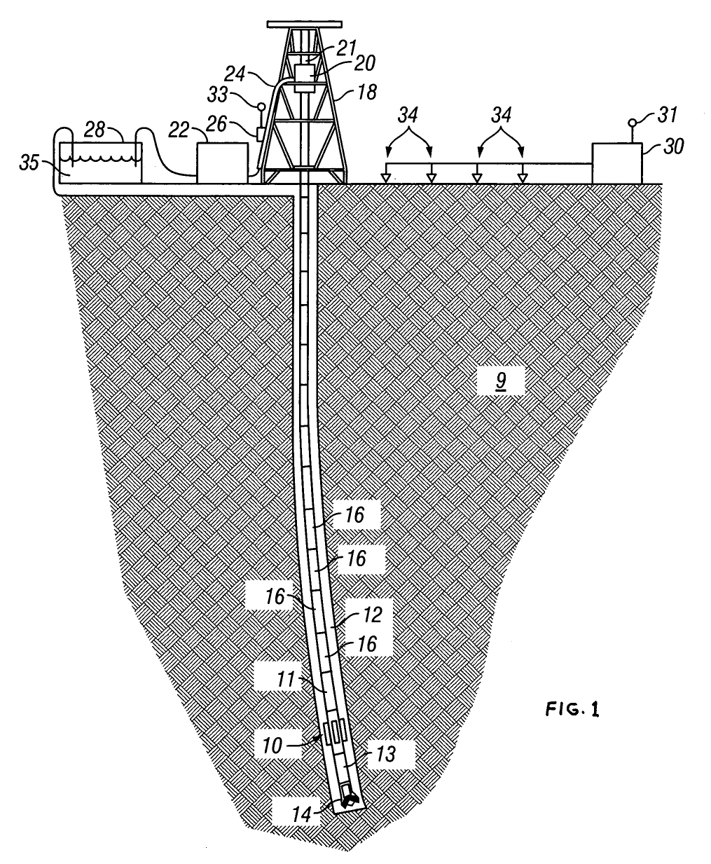

A drill string-conveyed seismic energy source 10 as it is typically used in a wellbore during drilling operations is shown generally in FIG. 1. The source 10 is shown disposed near the bottom end of a drill string disposed in a wellbore 12 being drilled through the earth 9. The drill string comprises threadedly coupled segments of drill pipe 16 that extend from a drilling rig 18 at the earth's surface to a bottom hole assembly (BHA) 11, the source 10, sub 13 and a drill bit 14 at the bottom of the drill string. As is known in the art a top drive 20 or similar device (or alternatively, a swivel, kelly, kelly bushing and rotary table—not shown in FIG. 1) are used to rotate the drill string and thus the bit 14 to drill through the earth 9. The BHA 11 may include components well known in the art such as drill collars, measurement while drilling (MWD) systems, stabilizers, reamers, and other drilling tools known in the art. The configuration of BHA 11, source 10 and drill pipe 16 shown in FIG. 1 is only representative of typical drilling tool assemblies that can be used with a source according to the invention, and therefore the configuration shown in FIG. 1 is in no way intended to limit the scope of the invention.

As is known in the art, the top drive 20 turns the drill pipe 16, BHA 11 and bit 14, and the bit 14 drills through the earth 9 using axial force provided by the weight of the drill pipe 16 and BHA 11 above the bit 14 as well as the rotational energy provided by the top drive 20. Other drilling systems may use hydraulic motors (“mud motors”—not shown in the figures) to turn the bit, however the actual source of the energy used to turn the bit is not a limitation on the scope of the invention. A mud pump 22 at the surface lifts drilling fluid (“mud”) 35 from a pit or tank 28 and pumps the mud 35 through a standpipe 24 in fluid communication with the interior of the drill pipe 16. The mud 35 flows downwardly through the drill pipe 16, BHA 11, source 10 and bit 14, where it is ultimately discharged through nozzles (not shown) in the bit 14. The mud 35 returns to the surface through the annular space between the pipe 16 and the wellbore 12, and is ultimately returned to the tank 28. The mud 35, among other functions, cools and lubricates the bit 14 and lifts drill cuttings to the surface for disposal. Other drilling systems may use different types of drilling fluid, for example, foam, compressed air or the like. Accordingly, the actual type of drilling fluid is not a limitation on the scope of the invention. As will be readily appreciated by those skilled in the art, using liquid for the drilling fluid provides the capability to communicate various signals from within the wellbore to the surface and vice versa using pressure modulation telemetry.

In the embodiment shown in FIG. 1, the standpipe 24 includes therein a pressure transducer 26 which measures mud pressure inside the standpipe 24. The pressure transducer 26 is operatively coupled to a control and recording unit 30. In the embodiment in FIG. 1, coupling the pressure transducer 26 to the recording unit 30 is performed by radio telemetry transceivers 33, 31 respectively. The pressure transducer measurements are used to detect a signal sent by a mud pressure modulation telemetry transmitter (not shown separately) disposed in the BHA 11. As is well known in the art, such mud pressure modulation telemetry systems are used to communicate selected signals from a measurement while drilling system (not shown separately) to the surface for detection, decoding and interpretation.

The recording unit in FIG. 1 is also operatively coupled to seismic receivers 34 disposed at the surface. In some embodiments, the seismic receivers 34 are geophones, either single- or multiple-component, of types well known in the art. In some embodiments, then seismic receivers 34 are combination geophone/hydrophone sensors disposed on the sea bottom wherein the drilling is performed in the ocean. In some embodiments, the seismic receivers 34 are hydrophones disposed near the water surface. The seismic receivers 34 may also be directly wired to the recording unit 30 or may communicate by radio telemetry (not shown) or the like.

In some embodiments a pilot sensor 21 is coupled or otherwise affixed to the top drive 20. Similarly multiple pilot sensors may be positioned on various parts of the drilling rig to detect drill string transmitted coupling of certain portions of the near bit energy spectrum that may be indicative of the signal quality generated by PDC type bits. The pilot sensor 21 may be an accelerometer oriented to measure axial acceleration of the drill string, or may be a strain gauge adapted to measure axial strain of the drill string (which is directly related to axial acceleration of the drill string). The pilot sensor 21 is operatively coupled to the recording unit 30, through radio telemetry (e.g. transceivers 31, 33) or hard-wired to the recording unit 30. Operation of and use of the signals from the pilot sensor 21 with respect to the source 10 will be further explained.

In the present embodiment, during drilling operations, the source 10 is programmed to self-actuate at selected time intervals. When the source 10 is actuated, seismic energy travels from the source 10 to the receivers 34 at the surface through the earth 9. As is well known in the art, some of the seismic energy from the source 10 travels directly to the earth's surface. Other seismic energy travels downwardly and outwardly to acoustic impedance boundaries (not shown) below the depth of the source 10, and reflects from such boundaries. The reflected seismic energy travels back upwardly through the earth 9 to the surface, where it is ultimately detected by the receivers 34. Such propagation and detection of seismic energy, and the interpretation of subsurface properties of the earth therefrom are well known in the art. Other embodiments may provide for signal telemetry from the earth's surface to the source 10 such that the source may be activated by command from the surface. Telemetry known in the art for communicating command signals from the surface to an instrument disposed in a wellbore include control of the flow of mud from the mud pump 22, changing rotation rate of the drill string and modulation of the pressure of the drilling mud at the earth's surface, one embodiment of which will be explained below in more detail.

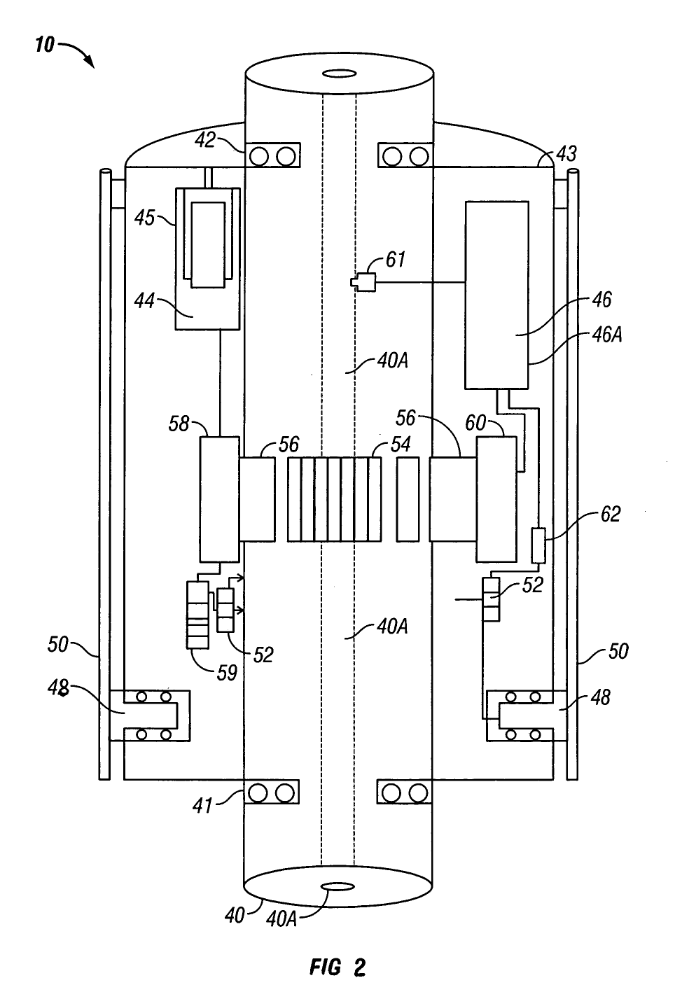

An embodiment of the source 10 is shown in more detail in a cross section in FIG. 2. Although indicated in this description as a seismic energy source, it should be noted that source 10 may also be utilized as a downhole steering tool. In the illustrated embodiment, the source 10 include a driveshaft 40 that can be threadedly coupled at each end thereof to a part of the drill string (shown as pipe segments 16, BHA 11, sub 13 and drill bit 14 in FIG. 1). Therefore, the drive shaft 40 rotates correspondingly with the drill string. A housing 43 is supported on an upper bearing 42 and a lower bearing 41 outside the drive shaft 40. The bearings 42, 41 enable the housing 43 to rotate relative to the drive shaft 40. Therefore, during drilling, the housing 43 may be substantially rotationally fixed, while the drive shaft 40 is free to rotate therein, thus enabling drilling to continue even as the source 10 operates. The drive shaft 40 includes a bore or passage 40A to enable flow of the drilling mud (35 in FIG. 1) through the drive shaft 40 to the drill bit (14 in FIG. 1).

The driveshaft 40 in the embodiment of FIG. 2 include splines 54 on its exterior surface at a selected position along the longitudinal axis of the drive shaft 40. The splines 54 are in rotational contact with reduction gear sets 56. The splines 54 and the reduction gear sets 56 convert the relative rotation of the drive shaft 40 with respect to the housing 43 into rotational energy to operate an hydraulic pump 58 and an electrical generator 60. Other embodiments may include various forms of a turbine to convert flow of the drilling mud into rotational energy to drive the generator 60. Still other embodiments may use stored energy, such as batteries. Using shaft rotation may provide the advantage of being able to generate electrical power in the source 10 itself without the need to have drilling mud flowing through the source 10.

The electrical generator 60 provides electrical power to operate control and signal processing circuits 46 disposed in a sealed chamber 46A in the housing 43. Functions that are provided by the circuits 46 will be further explained, however, it is contemplated that the circuits 46 will include a programmable central processor, driver circuits to operate throttling valves 59 and command interpretation circuits to decode control commands sent from the earth's surface. Such commands may be transmitted by modulating, at the earth's surface, the pressure of the drilling mud (35 in FIG. 1) as it flows through the drill string. Pressure modulation commands may be detected by a pressure transducer 61 disposed on the drive shaft 40 and electrically coupled to the circuits 46. Although not shown in FIG. 2, typical electrical connections between elements disposed in the drive shaft 40 (or any other rotating part of the drill string) and elements disposed in the housing 43 may be accomplished using slip rings or the like. Accordingly, the position and coupling of the transducer 61 in FIG. 2 is only intended to illustrate the principle of embodiments of the invention and is not to limit the scope of the invention. Transmitting commands and/or other signals from the Earth's surface to an instrument in a wellbore using mud pressure modulation telemetry is described, for example, in U.S. Pat. No. 5,113,579 issued to Scherbatskoy.

The hydraulic pump 58 draws hydraulic oil or the like from a reservoir 44 exposed to one side of a pressure compensation piston/spring combination 45 therein. The other side of the piston 45 is exposed to ambient fluid pressure in the wellbore (12 in FIG. 1). Such pressure compensated reservoir systems are well known in the art. In some embodiments, a static pressure in the reservoir 44 provided by the piston/spring 45 is 20 bar (about 300 PSI) above the hydrostatic (ambient) pressure of the mud (35 in FIG. 1) in the wellbore (12 in FIG. 1). Such static pressure reduces the possibility of mud (35 in FIG. 1) entering the reservoir 44 and also provides an engaging force to pistons 48, as will be further explained.

In some embodiments, the discharge side of the pump 58 is in hydraulic communication with a second reservoir or accumulator 59. The accumulator 59 in this embodiment stores hydraulic pressure from the pump 58 at a selected pressure in excess of the pressure in then reservoir 44. In some embodiments, the selected pressure is about 100 bar (1500 PSI). The accumulator 59 is hydraulically coupled to the input side of throttling valves 52. The throttling valves 52 may be solenoid operated, under control of the circuits 46. The throttling valves 52 operate to selectively couple the back side of the pistons 48 to the pressure in the accumulator 59, or the pressure in the reservoir 44. The other side of each of the pistons 48 is in contact with the back side of a corresponding one of a plurality of contact members or ribs 50. The front side of each of the contact member 50 is pressed against the wall of the wellbore (12 in FIG. 1) as the source 10 is operated. Therefore, depending on the selected hydraulic coupling of the throttling valves 52, the force exerted by each of the ribs 50 is higher or lower depending on whether the pistons 48 are in communication with reservoir 44 pressure or accumulator 59 pressure.

The present embodiment includes the ribs 50 to transmit force exerted by each corresponding piston 48; however, it should be clearly understood that each piston 48 may itself be urged directly into contact with the wall of the wellbore. In such embodiments, the piston itself forms the contact member. Other suitable contact members are also contemplated by the invention. Advantages of having separate ribs to contact the wall of the wellbore may include protection of the piston from damage due to scraping or gouging along the wellbore wall, and distribution of the force exerted by the piston over a wider area, reducing the possibility of causing mechanical breakdown of the wellbore wall at the contact point. Using ribs for contact members as shown in FIG. 2 is thus only one embodiment of a source according to the invention.

During operation of the source 10, the circuits 46 operate the throttling valves 59, in one embodiment, to alternately hydraulically couple the back side of the pistons 48 to the accumulator 59, and to the reservoir 44. Alternately hydraulically coupling the pistons 48 in this manner causes the pistons 48 to alternately exert larger and smaller force on the ribs 50, and thus to the wall of the wellbore (12 in FIG. 1). In some embodiments, the circuits 46 are programmed to operate the valves 59 to alternate the pressure applied to the pistons in a swept frequency band, through seismic frequencies of interest. In some embodiments, the frequencies are within a range of about 5 to 80 Hz. This form of operation of the pistons 48 will be familiar to those skilled in the art as similar to a surface deployed vibratory seismic energy source. One such source is sold under the trade name VIBROSEIS, which is a mark of ConocoPhillips, Inc., Houston, Tex.

In some embodiments, the pressure in the accumulator 59 is set very much higher than the external hydrostatic pressure. In these embodiments, the pressure in the accumulator 59 is discharged to the pistons 48 in the form of a short-duration impulse. FIG. 2 shows a cross section through the source 10. The cross section of FIG. 2 thus shows two opposed pistons 48 and ribs 50. The number of such pistons and ribs is not intended to limit the scope of the invention. In the present embodiment, there are four such pistons and ribs as shown in FIG. 2. In the present embodiment, the pistons are each separated from the adjacent pistons by about 90 degrees around the circumference of the housing 43.

Those familiar with the art of surface vibratory seismic sources will readily appreciate that by applying force from one or more of the ribs 50, the housing 43 becomes disposed in the wellbore in such a manner as to act as its own reactive mass. In surface vibrator type sources, a very large mass is swept through hydraulically controlled forces such as in the embodiment of FIG. 2. The large mass is provided in order to efficiently couple the seismic energy into the earth. In embodiments of a source disposed in a wellbore such as shown in FIG. 2, the source itself, either directly through the housing, or through one or more ribs 50 provides the required seismic energy coupling into the earth (9 in FIG. 1) through the wall of the wellbore (12 in FIG. 1).

It should also be understood that hydraulic actuation is only one form of selectively urging the ribs 50 into alternate high pressure and low pressure contact with the wellbore (12 in FIG. 1). Electric actuators such as solenoids may also provide the required actuation within the scope of this invention.

In some embodiments, the circuits 46 may be programmed to actuate the source 10 at specific, preselected times. These preselected times are synchronized with recording signals from the sensors (34 in FIG. 1) so that energy travel time may be determined. In these embodiments, a recording of the “sweep” of the source may be stored in the recording unit (30 in FIG. 1) so that swept vibration energy, if generated as explained above, can be correlated to the sensor signals to determine the impulse response of the earth (9 in FIG. 1) and the corresponding seismic travel time.

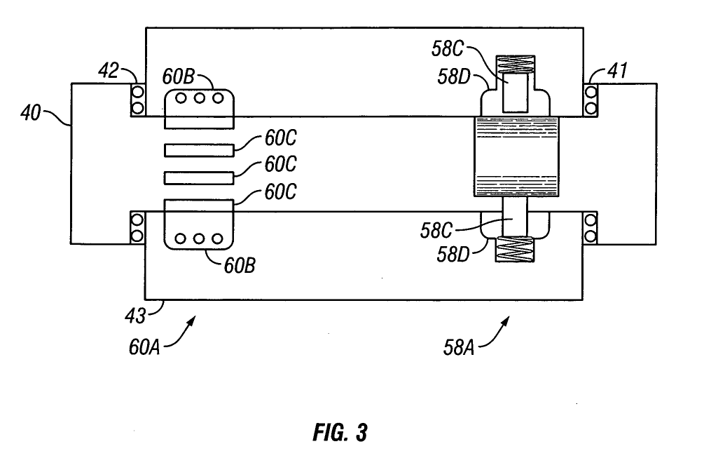

It should also be understood that the electric generator and hydraulic oil pump embodiments shown in FIG. 2 are not intended to limit the scope of the invention. FIG. 3 shows another embodiment of the generator 60A and oil pump 58A. The generator 60A includes magnets 60C coupled to the exterior surface of the drive shaft 40. A field coil or stator 60B can be disposed in a suitably formed recess in the interior of the housing 42, so as to dispose the stator 60B proximate the magnets 60C. Relative rotation between the drive shaft 40 and the housing causes the magnets 60C to rotate relative to the stator 60B, thus generating electricity.

The oil pump 58A in this embodiment includes an eccentric 58B coupled to or formed into the drive shaft 40 at a suitable location along the longitudinal axis of the drive shaft 40. At least one, and preferably a plurality of pistons 58C are disposed in cylinders 58D in corresponding axial positions along the interior of the housing 40. The pistons 58C are disposed so that motion of the eccentric 58B causes the pistons 58C to move in and out of their respective cylinders 58C. An alternative to the embodiment shown in FIG. 3 includes a wobble plate (not shown) as a substitute for the eccentric, and the pistons and cylinders are disposed so that the pistons move parallel to the axes of the drive shaft and housing in response to motion of the wobble plate.

Returning to FIG. 1, the purpose of the pilot sensor(s) 21 will now be explained in more detail. As explained in the Background section herein, signal communication from the wellbore 12 to the earth's surface using mud pressure modulation telemetry known in the art is relatively slow. In seismic signal interpretation, it is important to be able to determine the time at which seismic energy originates at the source (such as 10 in FIG. 1) in order to be able to determine energy travel time from the depth in then wellbore 12 to the surface. Although the source 10 may be programmed to actuate at selected times, the actual acoustic response of the source 10 in any particular formation within the earth 9 may not precisely match the source response under laboratory conditions. Accordingly, the pilot sensor 21 measures energy transmitted through the drill string from the source to determine an acoustic “signature” of the source in any formation. The signature may be determined by autocorrelation of the signal measured by the pilot sensor(s) 21. The signature thus determined may be used to generate a deconvolution operator to be applied to the sensor signals, to improve the fidelity of the signals 34. Autocorrelation and deconvolution techniques using pilot signals are known in the art. See, for example, U.S. Pat. No. 4,849,945 issued to Widrow, and U.S. Pat. No. 4,926,391 issued to Rector et al.

Alternatively, using the pilot sensor 21 in some embodiments eliminates the need to synchronize operation of the source 10 to the recordings made by the recording unit 30. In such embodiments, the pilot sensor 21 signal is cross-correlated to the sensor 34 signals to determine the impulse response of the earth. Travel time of the seismic energy through the drill string may be determined by calculating multiple reflection time of seismic energy transmitted along the drill string. Such multiple reflections are determined by autocorrelation of the pilot sensor 21 signal. Such techniques are well known in the art. See for example, U.S. Pat. No. 3,377,161 issued to Meehan, U.S. Pat. No. 4,718,048 issued to Staron et al. and U.S. Pat. No. 4,829,489 issued to Rector.

In some embodiments, the mode of operation of the source, including timing of operation, and whether the source is operated as a vibrator or impulsive source may be controlled by sending suitably formatted commands using mud pressure modulation telemetry. As previously explained with respect to FIG. 2, the pressure transducer 61 measures mud pressure inside the drill string, whereupon the commands resident in the mud pressure can be detected and decoded by the circuits 46.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seismic energy source for use while drilling a wellbore, comprising:
a drive shaft adapted to be coupled to a drill string;
a housing rotatably supported outside the drive shaft;
at least one contact member on an exterior of the housing and selectively urged into contact with a wall of a wellbore surrounding the housing; and
means for selectively controlling a laterally outward force applied to the at least one contact member, the means for selectively controlling adapted to control the laterally outward force so as to induce a seismic signal in the wellbore detectable at the Earth's surface.

2. The source as defined in claim 1, wherein the at least one contact member is engaged on one side with a means for applying the laterally outward force, the other side of the contact member being urged into contact with the wall of the wellbore by the means for applying the laterally outward force.

3. The source as defined in claim 1, wherein the means for selectively controlling comprises a throttling valve, an outlet of which is in hydraulic communication with one side of at least one piston, an inlet of the throttling valve in selectively controlled hydraulic communication with a first reservoir and a second reservoir, the second reservoir having a higher hydraulic fluid pressure than the first reservoir, the other side of the at least one piston operatively urged into contact with the wall of the wellbore.

4. The source as defined in claim 3, wherein the at least one piston forms the at least one contact member.

5. The source as defined in claim 3, further comprising a rib in contact on one side with the at least one piston, the other side of the rib urged into contact with the wall of the wellbore.

6. The source as defined in claim 3, further comprising means for operating the throttling valve to select between the first reservoir and the second reservoir by sweeping through a selected frequency range.

7. The source as defined in claim 3, wherein the second reservoir is charged to a pressure such that operating the throttling valve to select the second reservoir provides a pressure impulse to the piston.

8. The source as defined in claim 3, wherein the at least one piston comprises four pistons, each piston disposed between the housing and a corresponding rib, each of the pistons hydraulically coupled on one side to the throttling valve and adapted to urge the corresponding rib into contact with the wall of the wellbore.

9. The source as defined in claim 1, further comprising means for converting relative rotation between the drive shaft and the housing into at least one of hydraulic pressure to charge the accumulator and electrical power to operate electrical circuits proximate the source.

10. A method for generating seismic signals in a wellbore during drilling thereof, comprising:
selectively varying a laterally outward force on a contact member engaged with a wall of a wellbore, the contact member disposed on a housing rotatably supported on a driveshaft coupled to a drill string, the selectively varying adapted to cause generation of a seismic signal detectable at the Earth's surface.

11. The method as defined in claim 10, wherein selectively varying comprises changing between a higher force and a lower force within a swept frequency range.

12. The method as defined in claim 10, wherein selectively varying comprises changing to a higher force so as to generate a seismic impulse in the wellbore.

13. The method as defined in claim 10, further comprising detecting a seismic signal transmitted through the drill string proximate the Earth's surface, and cross correlating the seismic signal transmitted through the drill string with detected seismic signals transmitted through the Earth.

14. A method for preparing a seismic survey during drilling of a wellbore, comprising:
generating a seismic signal with a downhole steering tool while drilling a wellbore, the seismic signal operable to transmit through the Earth to the Earth's surface;
receiving the seismic signal at the Earth's surface; and
generating a seismic survey based on the seismic signal.

15. The method of claim 14, wherein generating a seismic signal comprises selectively varying a laterally outward force on a contact member of the downhole steering tool engaged with a wall of the wellbore.

16. The method as defined in claim 15, wherein selectively varying comprises changing between a higher force and a lower force within a swept frequency range.

17. The method as defined in claim 15, wherein selectively varying comprises changing to a higher force so as to generate a seismic impulse in the wellbore.

18. The method as defined in claim 14, further comprising cross correlating the seismic signal received at the Earth's surface with a second seismic signal transmitted through a drill string coupled to the downhole steering tool proximate the Earth's surface.
